(19) United States
(12) Patent Application Publication
(10) Pub. No.: US 2006/0282523 A1
(43) Pub. Date: Dec. 14, 2006

(54) System and method for non-obtrusive monitoring and control of remote services and control gateways

(76) Inventor: Frank Earl, Flower Mound, TX (US)

Correspondence Address: John A. Thomas, 13355 Noel Road, L.B. 48, Dallas, TX, 75240-1518, US

(21) Appl. No.: 11/148,481

(22) Filed: Jun. 9, 2005

(51) Int. Cl. G06F 15/173

(52) U.S. Cl. 709/224

(57) ABSTRACT

A computer system for monitoring and controlling remote services comprises at least one first processor executing a first set of instructions and at least one second processor executing a second set of instructions. The first processor and the second processor communicate through a packet-switched network. The second set of instructions causes the second processor to initiate a data communication with the first processor by means of a remote procedure call to the first processor, identify itself to the first processor, and accept commands from the first processor. The first set of instructions causes the first processor, after communications are initiated by the second processor, to receive data from the second processor and send control instructions to the second processor. The first processor is typically a host server computer and the second processor is typically a remote terminal unit.

### TECHNICAL FIELD

The present disclosure is concerned with non-obtrusive control of remote services and control gateways, and more particularly, a software system and method for controlling remote computer-based services and devices and gateways.

### BACKGROUND

Internet service providers desire the ability to remotely control certain aspects of Internet customers' services and such equipment. The Internet customers maybe located behind a gateway device between the Internet service provider and the Internet customers. In such case, the Internet service provider may desire to control the gateway devices.

In order to allow such control and access to an Internet service provider, the Internet customers must have a routable, Internet protocol (IP) address associated with the Internet customers' equipment. The methods currently in use are typically a web-based server or other device with a routable IP address directly connected to the Internet or on a gateway device or firewall-connected device.

However, routable IP addresses are less secure than non-routable IP addresses. For that reason, Internet customers are typically provided with a non-routable IP address and are behind a gateway or firewall device, and connected to the Internet through such firewall or gateway device. Accordingly, the Internet service provider has less access to the non-routable IP address of the Internet customers and less ability to control the device located behind the gateway device.

Prior-art methods for communicating with remotely-controlled devices include the Supervisory Control and Data Acquisition (SCADA) system, often used in industrial applications to control distributed systems from a master location, and the Short Message Service (SMS), used to send short text messages to and from mobile telephones.

In SCADA, the communications, data collection and control operations originate from the central host machine. Generally, the host machine sets up a communications session that is maintained indefinitely. This means the system is vulnerable to several kinds of attack, including brute-force dial-in attempts on the remote unit, man-in-the-middle attack, and bulk jamming. Such designs do not account for multiple communications pathways, which, in any event will not scale and will not work easily behind network firewalls, since they require an unbroken connection established by the host to the remote device.

The SMS provides text messaging to a mobile phone, but provides no control operations or return data.

What is needed is a secure channel for data collection and remote control of devices at a given location that can handle changing communications pathways. Such a communications channel should provide scaleable two-way communications behind networks using network address translation (NAT), as well as large numbers of remote units feeding data back to the host system.

### SUMMARY

The present disclosure comprises a computer program and a remote procedure call (RPC) method to establish communication between an Internet service provider server and a remote Internet customer's device.

A computer system for monitoring and controlling remote services comprises at least one first processor executing a first set of instructions and at least one second processor executing a second set of instructions. The first processor and the second processor communicate through a packet-switched network. The second set of instructions causes the second processor to initiate a data communication with the first processor by means of a remote procedure call to the first processor, identify itself to the first processor, and accept commands from the first processor. The first set of instructions causes the first processor, after communications are initiated by the second processor, to receive data from the second processor and send control instructions to the second processor. The first processor is typically a host server computer of an Internet service provider, and the second processor is typically a remote terminal unit.

The remote terminal unit associated with the Internet customer's service or a gateway device or firewall device may initiate a communication event with an Internet service provider server at a regularly scheduled time event or at the instance of certain non-scheduled events.

The remote terminal unit or gateway device or firewall device may provide information to the Internet service provider server so that enables the Internet service provider server can receive data from the remote terminal unit or gateway device or firewall device and assert control over certain functions of the remote terminal unit or gateway device or firewall device. The Internet service provider to communicate with the Internet customers' devices that are connected to the gateway device or firewall device, such as a thermostatic control for an air conditioner compressor, a lighting network, a security network, a transducer or measurement instrument, or other device capable of remote control.

The system and method disclosed thus maintains the security of the remote terminal unit by enabling communication between the Internet service provider and remote terminal unit without the necessity of assigning a less secure routable IP address to the remote terminal unit. The system and method disclosed provide that the routable IP address remains associated with a gateway device or firewall device that has inherent security features.

The system and method disclosed are further configured to allow for load balancing of the tasks that the Internet service provider server controls. Also, the system and method allows the Internet service provider server to control certain elements of the Internet customer's device and to load, edit and remove software elements from such Internet customer's device.

### BRIEF DESCRIPTION OF THE DRAWINGS

FIG. 1 is a schematic diagram illustrating an a host Internet service provider and to the Internet and the gateway connection to the Internet customer device.

FIG. 2 is a diagram illustrating a host or gateway device communicating with a remote terminal unit using a remote procedure call (RPC).

FIG. 3 is a schematic diagram of a typical remote terminal unit in the preferred embodiment.

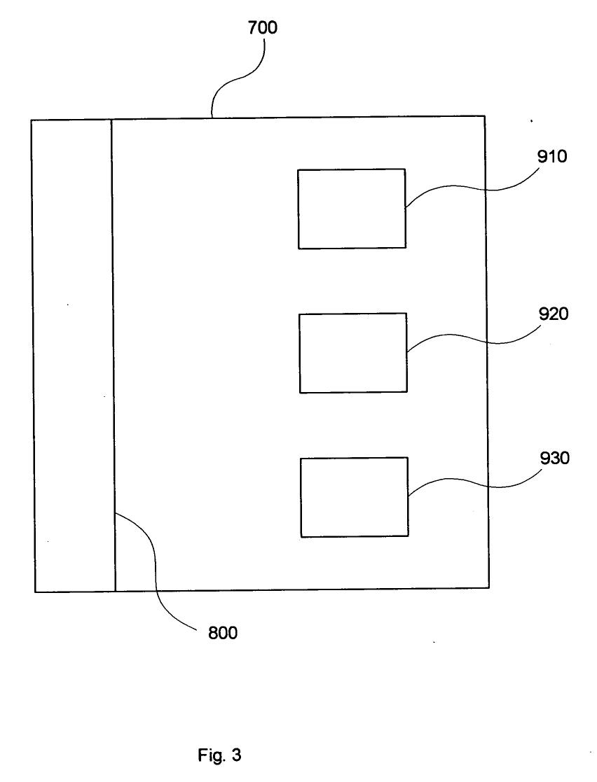

FIG. 4 is a flow chart diagram illustrating an Internet customer control software package and method for communicating with a host server computer.

FIG. 5 is a flow chart diagram illustrating a gateway device control software method for communicating between a host Internet service provider and a gateway device with a remote procedure call.

FIG. 6 is a flow chart diagram illustrating a host Internet service provider control software package and method for communicating with a gateway computer.

FIG. 7 is a flow chart diagram illustrating a host Internet service provider control software and method for communicating with a gateway device or a remote terminal unit with a remote procedure call.

### DETAILED DESCRIPTION

A host server computer (100) may be used to monitor and control a remote terminal unit (170) or multiple remote terminal units (RTU). The number of remote terminal units may be increased or decreased. Communication between the host server computer (100) and the RTU (170) may be accomplished by transmission and receipt of electronic data by any means of electronic or electrical communication, such as an Internet connection, a local area network (LAN), modem connection or other similar means.

Typically, Internet connections and LAN systems include a gateway device located between the Internet and the LAN or the RTU. The use of a gateway device is well known in the programming art. The gateway device prevents direct communication between the Internet and a RTU located behind the gateway device. In such instance, the host server computer (100) will communicate with the gateway device (130).

The remote terminal units (170) may be any type of device capable of producing a digital or analog signal such as a thermostatic control device in a home or business, a fire alarm monitor, sound or video card, transducer, or other similar device.

The host server computer (100) may be any type of computer with the capability to receive data from external input devices such as network interface cards, modems, keyboards or other input device. The host server computer (100) may have the capability to aggregate and process data from such input devices. The host server computer (100) may have the capability to output data and instructions in a form that may include data packets. Data packets will contain logical combinations of data to be transmitted by a wire or combination of wire, bus or other means of electronic data transmission. The logical combinations of data will be arranged in logical sequence defining the source of the data information, the expected length of the data information packet, the designated destination of the data information packet and will further include the data payload of information to be transmitted within the packet. The host computer server (100) will interpret its intended message payload.

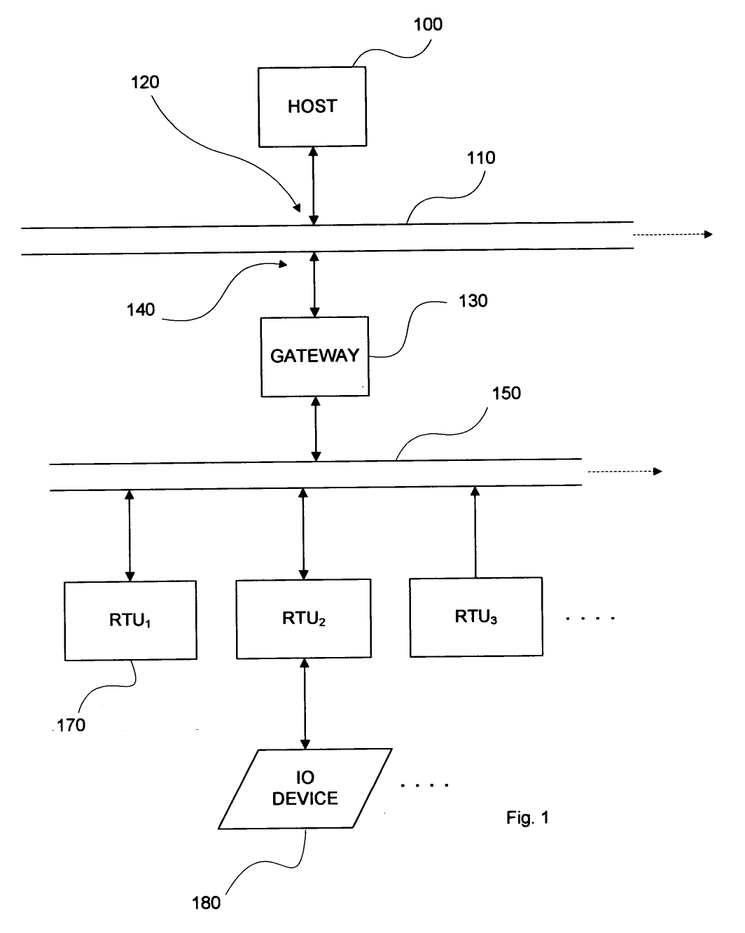

FIG. 1 is a block diagram showing schematically the connections between a host computer (100), an Internet bus (110), an Internet connection (120) between the host server computer (100) and the Internet (110), a gateway device (130), an Internet connection (140) between the gateway device (130) and the Internet (110), a LAN (150) connected to the gateway device (130), and a plurality of remote terminal units (170), each RTU (170) being connected to one or more input/output devices (180).

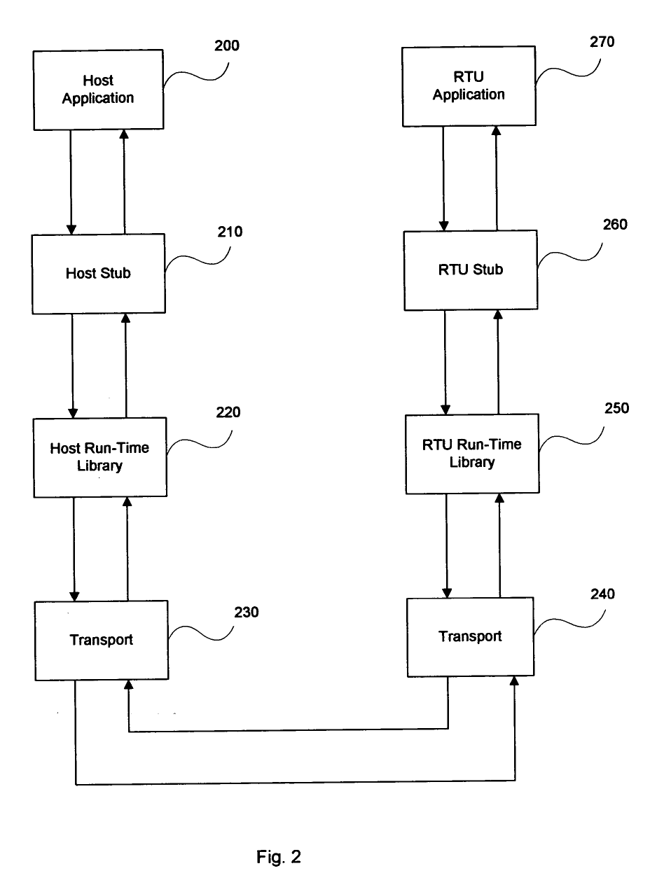

As shown in FIG. 2 and as discussed below, each remote terminal unit (170) includes a self-contained or local computer (300) having a microprocessor (310). Each remote terminal unit may include one or more random-access memory devices (320) and may further include one or more read-only memory devices (330) with a stored program.

In the preferred embodiment, the gateway device (130) communicates with the remote terminal units (170) through a high-speed data connection, such as the Ethernet standard. Preferably, communications between the gateway device (130) and the remote terminal units (170) is done using the TCP/IP or UDP protocols. Other packet protocols may be used, however, such as IPX or X.25.

In the preferred embodiment, the host server computer (100) is connected directly to the Internet (110). Alternatively, the host server computer (100) may be connected to an intermediate host server that is connected directly to the Internet (110). The host server computer (100) operates using a standard operating software platform such as Linux or other operating system.

The host server computer (100) aggregates data received from various sources, including input commands provided by an operator, input data packets from a gateway device (130), or a remote terminal unit (170), or other input source. The host server computer (100) communicates with the gateway device (130) or the remote terminal unit (170) by providing queued commands stored on the host server computer (100) in memory storage arrays or dynamic linked lists, or other means for storage of commands. The host server computer (100) may communicate with the gateway device (130) or the remote terminal units (170) with a handshaking process. Handshaking protocols are well-known in the computer art. The system components are preferably configured to authenticate the server components by authentication of the server by the gateway communication handler or for authentication of the gateway communication handler by the server. Authentication methods are well-known in the computer art.

A remote terminal unit (170) or a gateway device (130) initiates the communication process with the host server computer (100) by a remote procedure call (RPC). The use of a remote procedure call is well known in the programming art. In the preferred embodiment, a remote terminal unit (170) or a gateway device (130) is programmed to initiate a communication with the host server computer (100) by transmitting a packet or a plurality of packets of data, using an appropriate protocol, to the host server computer (100).

The remote procedure call scheme of the preferred embodiment is shown in FIG. 2. A host application (200), running on the host server computer (100) (or, in some embodiments, a gateway (130)), calls a local stub procedure (210) instead of the actual code in the RTU application (270). The host stub (210) translates the parameters needed into a standard format for network transmission, and calls functions in the host run-time library (220) to send the request and its parameters over the network (230). The remote procedure, the RTU application (270) returns its data to its RTU stub (260), which then calls its run-time library (250) to transmit the data over the network (240), back to the host application (200). The reverse procedure is used when the RTU application calls procedures in the host application. In any case, in the preferred embodiment, the RTU always initiates the communication.

The initiated communication packets may contain a software request for a response from the host server computer (100) or a gateway device (130) to establish a dynamic link between the remote terminal unit (170) or a gateway device (130). The initiated communication packets may contain a request to initiate a transmission from the host server computer (100) or a gateway device (170) to download a packet or a plurality of packets of data, using an appropriate protocol, from the host server computer (100) to the remote terminal unit (170) or to a gateway device (130). The initiated communication packets may contain a packet or a plurality of packets of data, using an appropriate protocol, to be stored by the host server computer (100)

There is no permanent connection between the host server computer (100) (or gateway device (130)); the RTU (170) initiates the conversation, and the host server computer (100) never tries to reach the RTU (170) directly. Thus, RTU's located behind a NAT network can be part of the monitoring network without establishing another IP network to accomplish this, or risk a security compromise by setting up a device on the outside of a firewall that an attacker can communicate directly with.

Once a remote terminal unit (170) has established a communication process with the host server computer (100), the host server computer (100) may communicate with the remote terminal unit (170) through the gateway device (130). In another embodiment, the remote terminal unit (170) may initiate a communication process with a gateway device (130), by means of a packet or a plurality of packets of data, using an appropriate protocol.

Remote terminal units (170) may be added or removed as needed. In the preferred embodiment, each remote terminal device (170) has a resident program capable of identifying the remote terminal device (170) to a host server computer (100) or a gateway device (130), using the Plug and Play standard or a similar program. In other embodiments, a remote terminal unit (170) may be pre-configured with embedded software to recognize or to be recognized by the host server computer (100) or a gateway device (130).

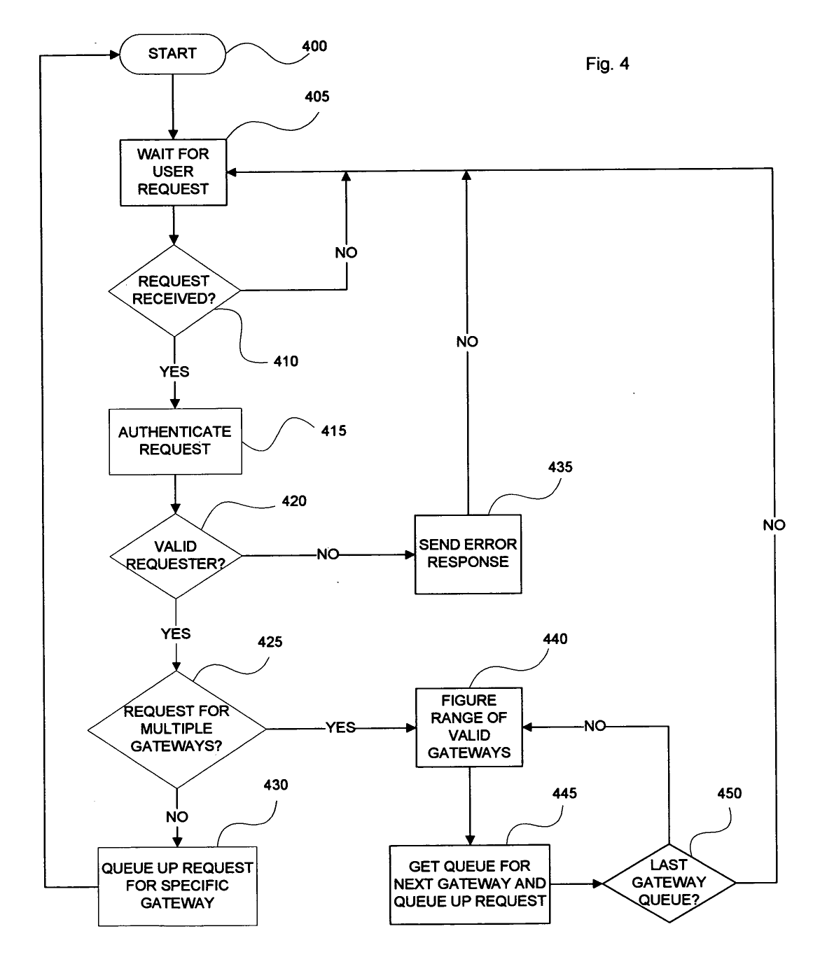

FIGS. 4, 5, 6 and 7 show the flow of execution of the program stored on the host server computer (100) and on the gateway device (130) or a remote terminal unit (170). The host server computer (100) typically has a central processing unit (CPU), a media-storage unit for one or more read-only memory devices, one or more random-access memory devices with a stored, software code program and may be suitably configured for running a commercial operating system such as the Linux operating system or the WINDOWS 2000 operating system by Microsoft Corporation. Preferably, the control program will have a graphical user interface. Design of graphical user interfaces is well known in the programming art.

FIG. 4 depicts the flow of execution of the program stored on the host server computer (100) when the host server computer (100) receives input information from an operator or other input device configured to deliver an instruction to the host server computer (100) for delivery to the gateway device (130) or remote terminal unit (170). At the start step (400), the host server computer (100) has been powered up. At step 405, the host server computer (100) waits for an input from the operator or from a source recognized as an input. If no request is received, the host server computer (100) continues to wait (410). When the host server computer (100) receives a request from the operator or other recognized source, the program evaluates the identity of the requester through a unique password or login code (415). If the program does not recognize the requester, an error message is generated (435) and the host server computer (100) continues to wait for a valid request at step 405. If a valid requester is recognized, the program determines the number of gateway devices or remote terminal units are to be addressed by the instruction (425).

If the instruction is only intended for one gateway device (130) or remote terminal unit (170), the program will establish a queue for the information to be stored at step 430, store the information in the queue, and return to the wait status step 405. If the instruction is intended for multiple gateway devices (130) or remote terminal units (170), the program determines the number and identity of gateway devices (130) or remote terminal units (170) at step 440, creates and queues up the instruction for the next gateway device (130) or remote terminal unit (170) at step 445, and then queries whether another gateway (130) or remote terminal unit (170) has been identified at step 450. If no other gateway (130) or remote terminal unit (170) has been identified, control returns to the host server computer (100) to the wait stage at step 405 after completion of the last instruction in the queue.

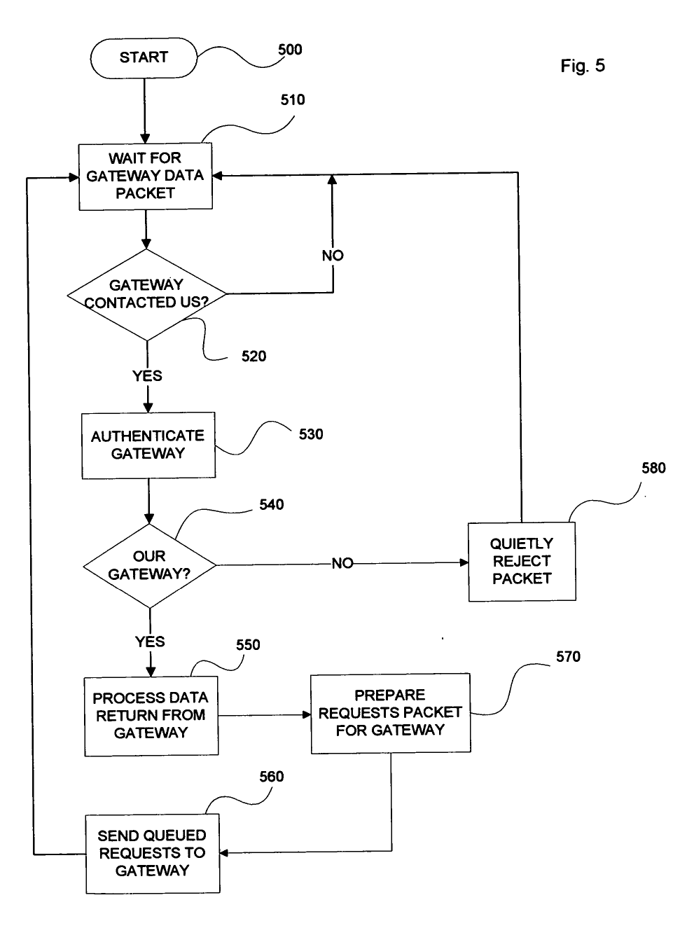

FIG. 5 depicts the flow of execution of the program stored on the host server computer (100) when the host server computer (100) receives input information from a gateway device (130) or from a remote terminal unit (170). At the start step (500), the host server computer (100) has been powered up. At step 510, the host server computer (100) waits for an input data packet from a gateway device (130) or a remote terminal unit (170). If no input data packet is received, the host server computer (100) continues to wait at step 510.

When the host server computer (100) receives an input data packet request from a gateway device (130) or a remote terminal unit (170), the program evaluates the identity of the a gateway device (130) or a remote terminal unit (170) through a unique identification code at step 530. If the program does not recognize the gateway device (130) or a remote terminal unit (130), an error message is generated at step 580 and the host server computer (100) continues to wait for a valid data packet at step 510. If a valid gateway device (130) or a remote terminal unit (170) is recognized, the program processes the data packet from the gateway device (130) or a remote terminal unit (170) at step 550, and further prepares and sends the previously queued information packet for the gateway devices (130) or remote terminal units (170) to be addressed by the instruction at step 570. After the program delivers the information packet to the gateway device (130) or remote terminal unit (170), the program returns to the wait step at 510.

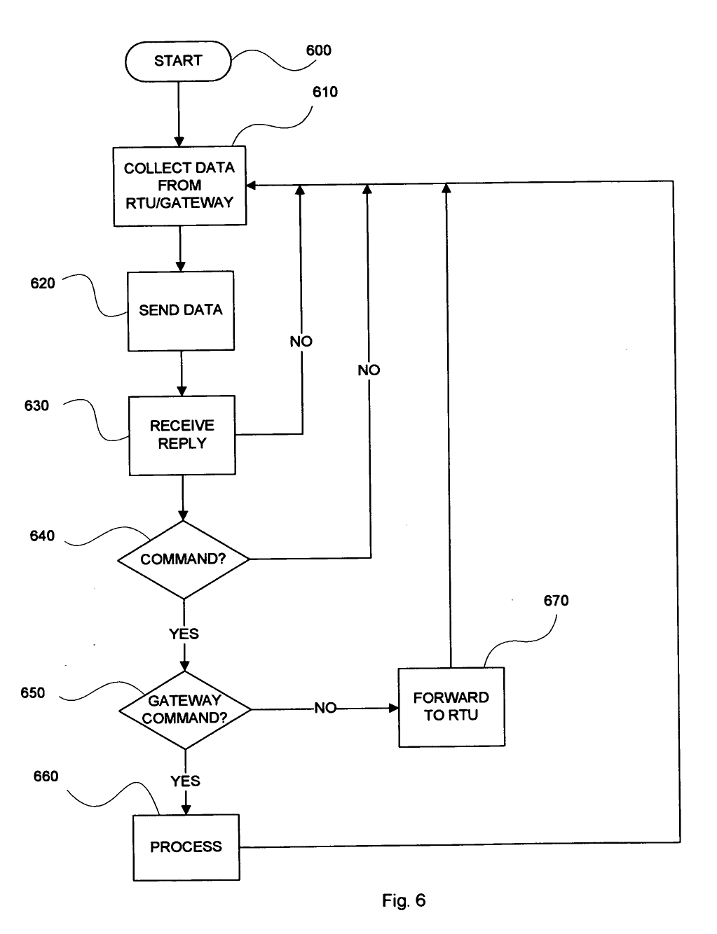

FIG. 6 depicts the flow of execution of the program stored on a gateway device (130) when the gateway device (130) initiates a data packet or receives a data packet from a remote terminal unit (170) to be directed to a host server computer (100). At the start step 600, the gateway device has been powered up. At step 610, the gateway device (130) collects data from an input source associated with the gateway device (130) or from a remote terminal unit (170). When the gateway device (130) collects and organizes a data packet, the gateway device (130) transmits the data packet to a host server computer (100) at step 620.

After transmitting a data packet, the gateway device (130) listens for a reply from the host server computer (100) at step 630. If no reply is received, the program returns the gateway device (130) to the wait step and prepares to collect more data at step 610. If a reply is received from the host server computer (100) at step 630, the program queries whether the reply contains a command to be executed by the gateway device (130) at step 640. If no command is received, the program returns the gateway device (130) to the wait step 610 and prepares to collect more data. If a command is received, the gateway device (130) determines if the command is directed to the gateway device (130) or to the remote terminal unit (170) at step 650. If the command is directed to the gateway device (130), the command is processed by the gateway device (130) at step 660 and the program returns the gateway device (130) to the wait step 610, where it waits to collect more data. If the command is directed to the remote terminal unit (170), the command is directed to and processed by the remote terminal unit (170) at step 670 and the program returns the gateway device (130) to the wait stage and waits to collect more data at step 610.

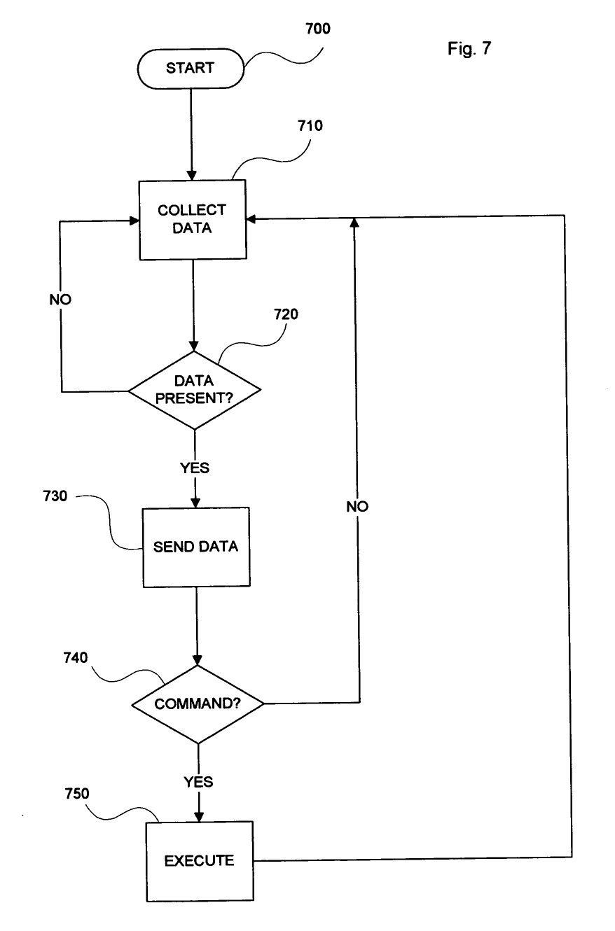

FIG. 7 depicts the flow of execution of the program stored on a gateway device (130) or a remote terminal unit (170) when the gateway device (130) or remote terminal unit (170) initiates a data packet to be directed to a gateway device (130) or to a host server computer (100). At the start step 700 the gateway device (170) has been powered up. At step 710, the gateway device (130) or remote terminal unit (170) collects data from an input source associated with the gateway device (130) or from the remote terminal unit (170). When the gateway device (130) or remote terminal unit (170) determines that data is present at step 720, the data is collected and organized into a data packet and the gateway device (130) or remote terminal unit (170) transmits the data packet to a gateway device (130) or to a host server computer (100) at step 730. After transmitting a data packet, the gateway device (130) listens for a reply from the host server computer (100) at step 740. If no reply is received, the program returns the gateway device (130) or remote terminal unit (170) to the wait step at 710 and waits to collect more data at step 710. If a reply is received from the host server computer (100) at step 740, the program queries whether the reply contains a command to be executed by the gateway device (130). If no command is received, the program returns the gateway device (130) to the wait step and prepares to collect more data (170). If a reply command is received, the command is processed by the gateway device (130) or remote terminal unit (170) at step 750, and the program returns the gateway device (130) or remote terminal unit (170) to the wait step and prepares to collect more data.

I claim:

1. A computer system for monitoring and controlling remote services, the computer system comprising:
at least one first processor executing a first set of instructions,
at least one second processor executing a second set of instructions;
the first processor and the second processor communicating through a packet-switched network;
where the second set of instructions causes the second processor to:
initiate a data communication with the first processor by means of a remote procedure call to the first processor;
identify itself to the first processor,
accept commands from the first processor, and,
where the first set of instructions causes the first processor, after communications are initiated by the second processor, to:
receive data from the second processor, and,
send control instructions to the second processor.

2. The computer system of claim 1 where the first processor is a host server computer and the second processor is a remote terminal unit.

3. The computer system of claim 2 where at least one of the remote terminal units initiates a communication event with the host server computer at a regularly scheduled time.

4. The computer system of claim 2 where at least one of the remote terminal units initiates a communication event with the host server computer at the instance of a predetermined, non-scheduled event.

5. The computer system of claim 1 where first processor is a gateway device and the second processor is a remote terminal unit.

5. The computer system of claim 1 where the second processor further comprises an input-output device.

6. The computer system of claim 1 where the first processor is a host server computer and the second processor is a gateway device.

7. The computer system of claim 6, further including a remote terminal device operatively connected to the gateway device.

8. The computer system of claim 1 where the first set of instructions is configured to reside on an individual server computer system.

9. The computer system of claim 1 where the first set of instructions is configured to reside on a collection of server computer systems connected by a local area network.

10. The computer system of claim 2 where the first set of instructions is configured to allow the host server computer to load, edit and remove software from at least one of the remote terminal units.

11. The computer system of claim 6 where the first set of instructions is configured to allow the host server computer to load, edit and remove software from at least one of the gateway devices.

12. The computer system of claim 1 where the first set of instructions is configured to allow each host computer server to interpret its intended message payload.

13. A method for monitoring and controlling remotes services and control gateways, comprising:
providing a host computer server connected to a network;
providing a remote terminal unit connected to the network;
initiating from the remote terminal unit a communications session between the remote terminal unit and the host computer server by means of a remote procedure call;
accepting data to the host computer server from the remote terminal unit;
queuing commands for the remote terminal unit in storage on the host computer server;
providing queued commands stored on the host computer server to the remote terminal unit; and,
ending the communications session.

14. The method of claim 16, further comprising:
providing a gateway device operatively connected between the host computer server and the remote terminal unit;
providing stored commands on the host computer server to the gateway device; and,
determining, in the gateway device, if the command is directed to the gateway device, or if the command is directed to the remote terminal unit.

15. The method of claim 14, where the step of initiating from the remote terminal unit a communications session between the remote terminal unit and the host computer server by means of a remote procedure call further comprises:
first initiating from the remote terminal unit a communications session with the gateway device; and, then,
initiating from the gateway device a communications session with the host computer server;
sending data from the remote terminal unit to the host computer server through the gateway device; and,
accepting commands from the host computer server through the gateway device.

16. The method of claim 13, further comprising authenticating the remote terminal unit to the host computer server.

17. A computer-readable medium having computer-executable instructions for performing a method comprising:
providing a host computer server connected to a network;
providing a remote terminal unit connected to the network;
initiating from the remote terminal unit a communications session between the remote terminal unit and the host computer server by means of a remote procedure call;
accepting data to the host computer server from the remote terminal unit;
queuing commands for the remote terminal unit in storage on the host computer server,
providing queued commands stored on the host computer server to the remote terminal unit; and,
ending the communications session.

18. The computer-readable medium of claim 17, where the computer-executable instructions further comprise:
providing a gateway device operatively connected between the host computer server and the remote terminal unit;
providing stored commands on the host computer server to the gateway device; and,
determining, in the gateway device, if the command is directed to the gateway device, or if the command is directed to the remote terminal unit.

19. The computer-readable medium of claim 18, where the computer-executable instructions further comprise:
first initiating from the remote terminal unit a communications session with the gateway device; and, then,
initiating from the gateway device a communications session with the host computer server;
sending data from the remote terminal unit to the host computer server through the gateway device; and,
accepting commands from the host computer server through the gateway device.

20. The computer-readable medium of claim 16, where the computer-executable instructions further comprise authenticating the remote terminal unit to the host computer server.
